(19) United States
(12) Patent Application Publication
(10) Pub. No.: US 2011/0247513 A1
(43) Pub. Date: Oct. 13, 2011

(54) Printer and table structure for supporting and supplying groups of products in such a printer

(75) Inventor: Paolo Cappa, Celle Ligure (SV) (IT)

(73) Assignee: Cabur S.r.I, Altare (SV) (IT)

(21) Appl. No.: 12/932,311

(22) Filed: Feb. 23, 2011

(30) Foreign Application Priority Data
Apr. 9, 2010 (IT) MI2010A 000604

(51) Int. Cl. B41F 1/30

(52) U.S. Cl. 101/408

(57) ABSTRACT

A printer (10) for groups of products (101) supported on a table structure (100) comprising a housing (11) for receiving a plurality of tables (100) placed one on another, means for orienting (12) the tables (100) in the housing (11) as regard to the printer (10), means for supplying (13) of a single table (100) at a time from the housing (11) to an advancing plane (14) towards a printing head (15) and means for moving (16) the single table (100) on the advancing plane (14), in which the means for supplying (13) of a single table at a time from the housing to the advancing plane towards the printing head comprise leafing devices (13) placed laterally and in a lower portion of the housing (11), the leafing devices (13) being mobile between a first position in which they maintain lifted the pile of tables (100) from the advancing plane (14) and a second position in which a single table (100) drops from the housing (11) on the advancing plane (14).

The present invention refers to a printer and to a table structure for supporting and supplying groups of products in such a printer.

Currently, there are many different types of printers for products that are collected in groups in a table structure.

Usually, in such printers, the aforementioned tables of products are piled up in a loader and subsequently supplied one at a time to a printing head.

It is thus clearly important to be able to safely move the tables both in the step of unloading from the loader, and in the step of advancing towards the printing head.

Indeed, if the tables are not unloaded correctly and if their advancing is not controlled, there will necessarily be obvious errors in the printed product.

The purpose of the present invention is that of making a printer and a table structure for supporting and supplying groups of supports in such a printer, that are capable of solving the aforementioned drawbacks with respect to the prior art, in an extremely simple, cost-effective and particularly functional manner.

Another purpose is that of making a printer and a table structure for supporting and supplying groups of supports to such a printer in which the unloading of the tables from the relative loader and their subsequent advancing step towards the printing head occur smoothly and without positioning errors.

These purposes according to the present invention are achieved by making a printer and a table structure for supporting and supplying groups of supports in such a printer, as outlined in claims 1 and 7, respectively.

Further characteristics of the invention are highlighted in the dependent claims.

The characteristics and the advantages of a printer and of a table structure for supporting and supplying groups of supports to such a printer according to the present invention shall become clearer from the following description, given as an example and not for limiting purposes, with reference to the attached schematic drawings, in which:

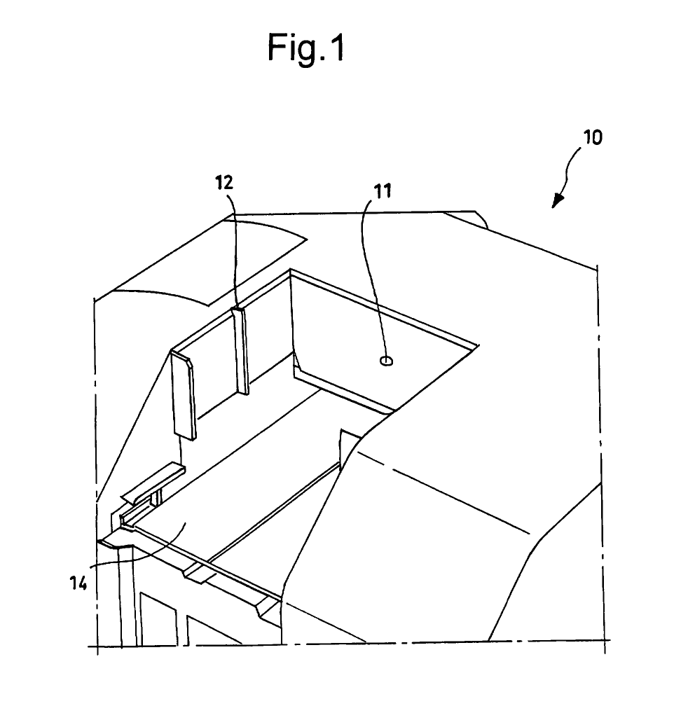

FIG. 1 is a partial perspective view of a printer according to the present invention;

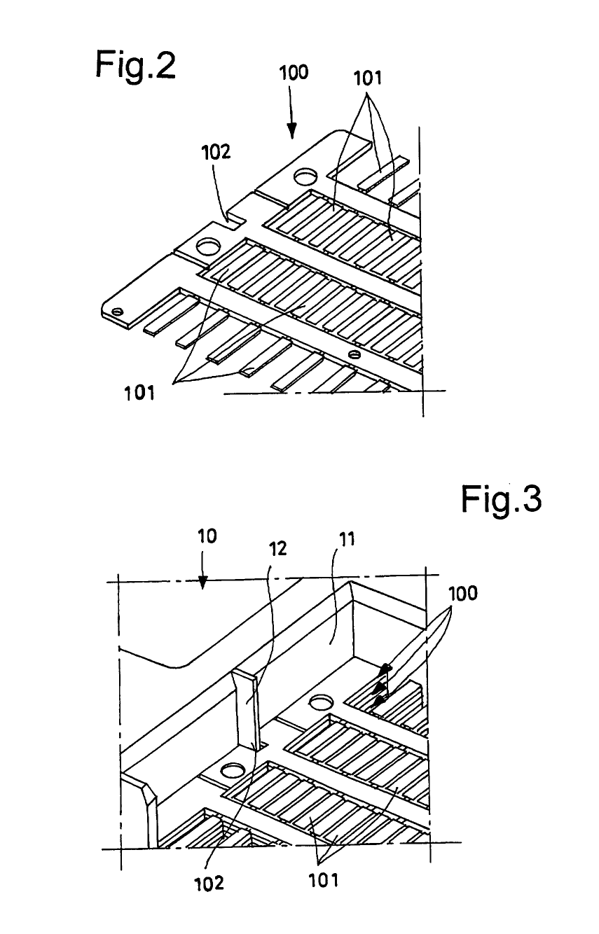

FIG. 2 is a partial perspective view of a table structure for supporting and supplying groups of supports in the printer of FIG. 1;

FIG. 3 is a perspective view of the printer of FIG. 1 loaded with a series of tables of FIG. 2;

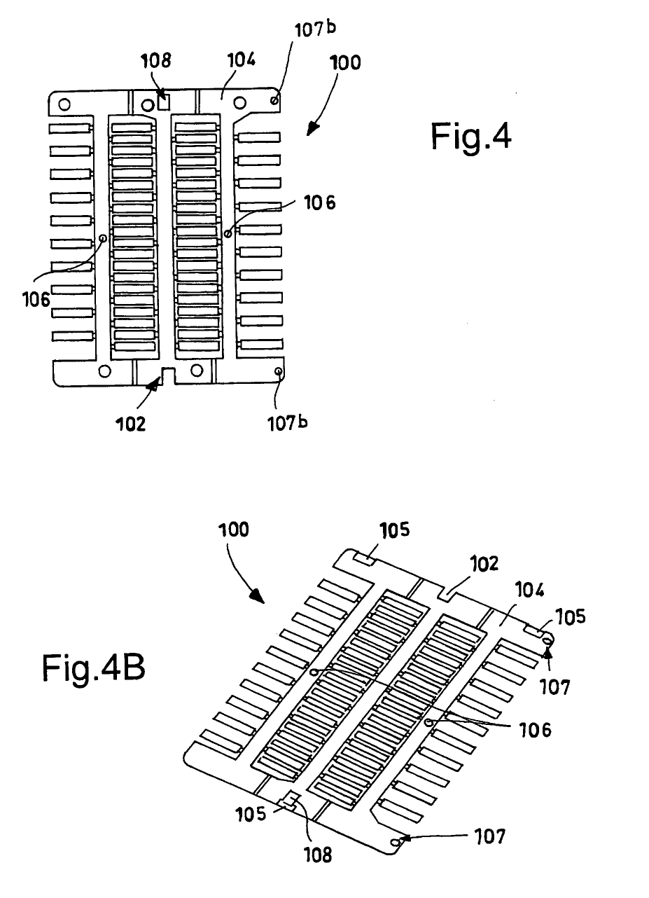

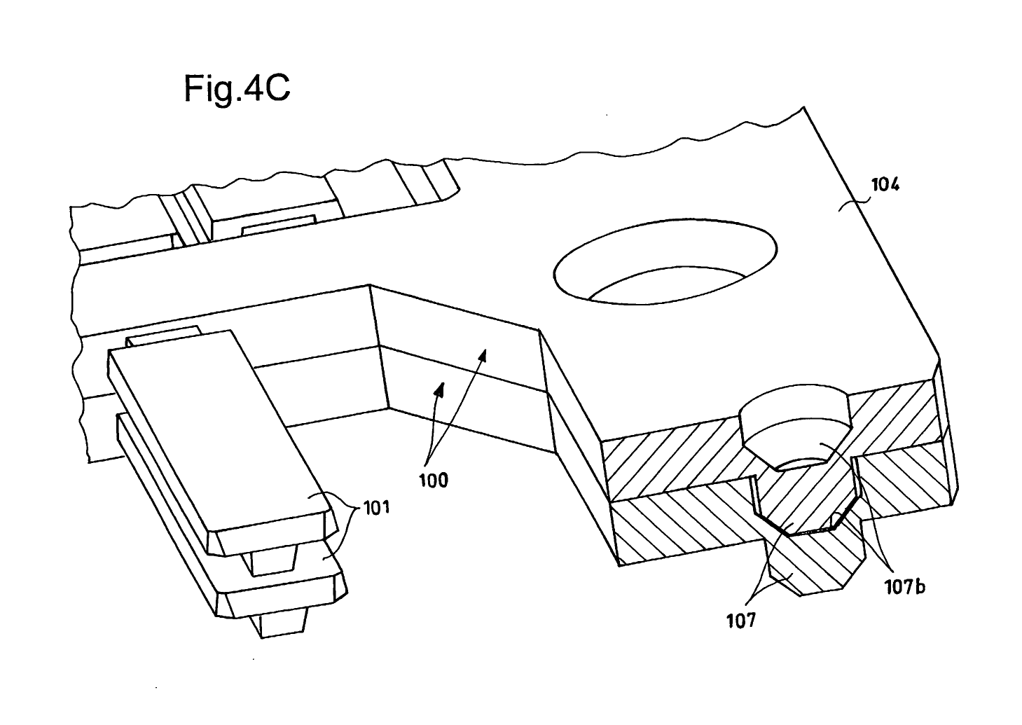

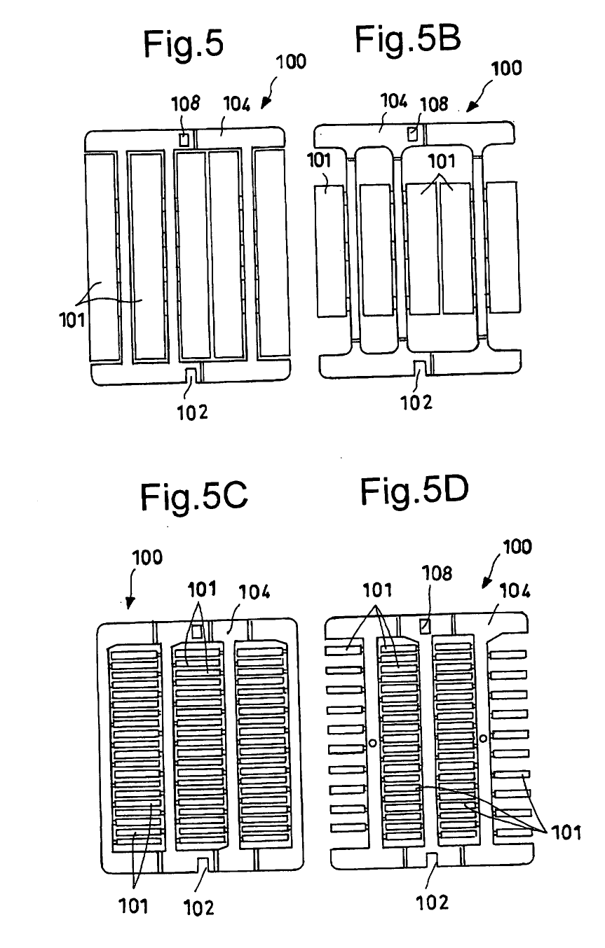

FIGS. 4, 4B, 5, 5B, 5C, 5D show different examples of table structures for supporting and supplying groups of supports in the printer of FIG. 1;

FIG. 4C shows two piled table structures;

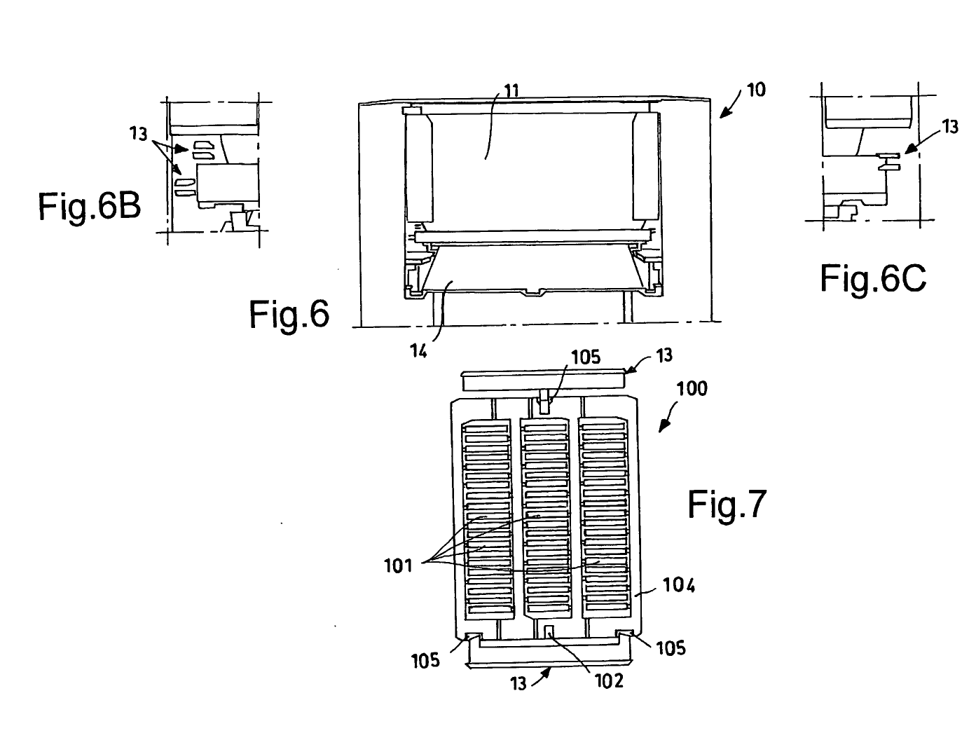

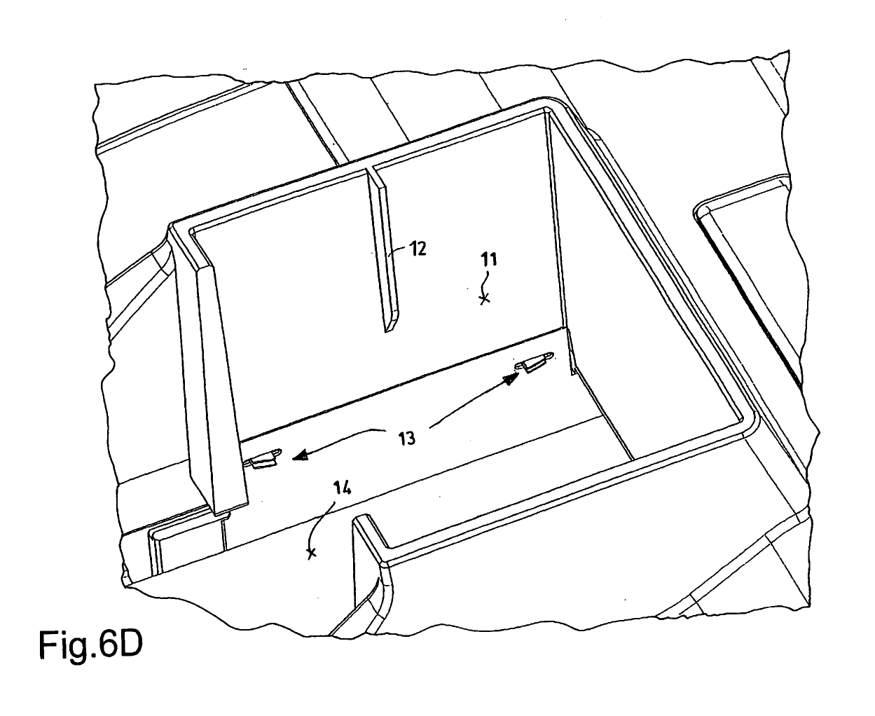

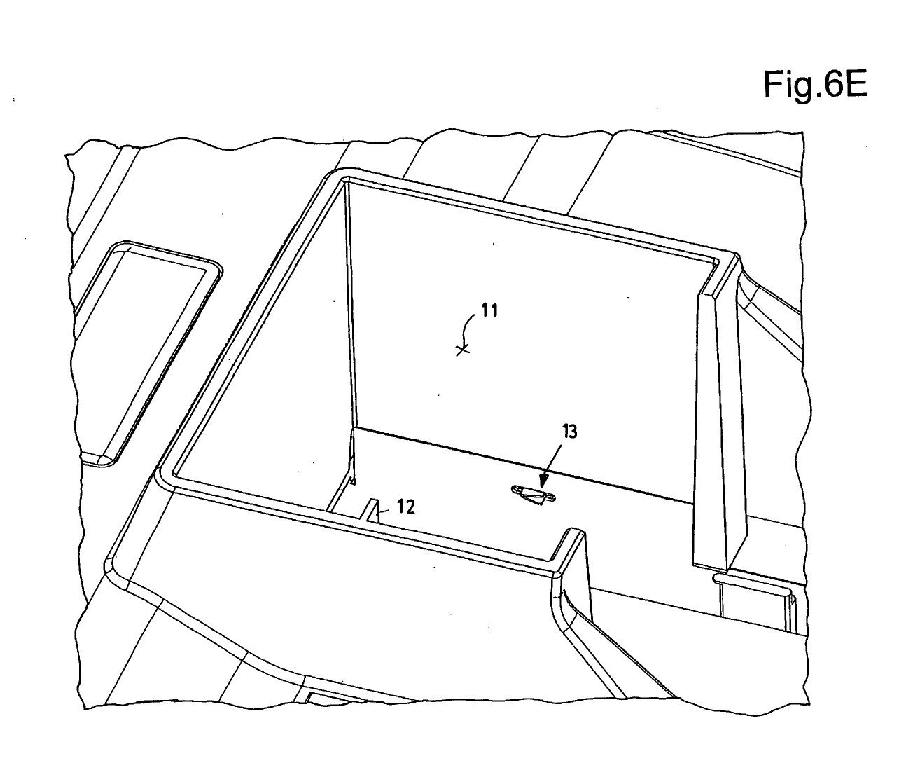

FIGS. 6, 6B, 6C, 6D, 6E show constructive details of the printer of FIG. 1;

FIG. 7 shows the constructive details of the FIGS. 6, 6B, 6C while they are cooperating with a table;

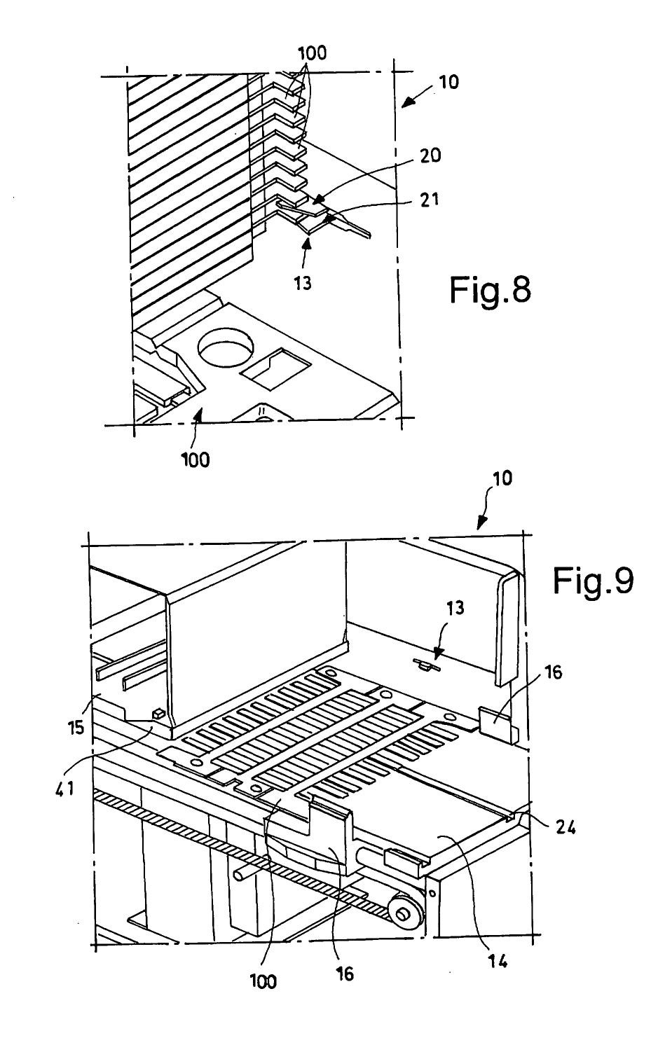

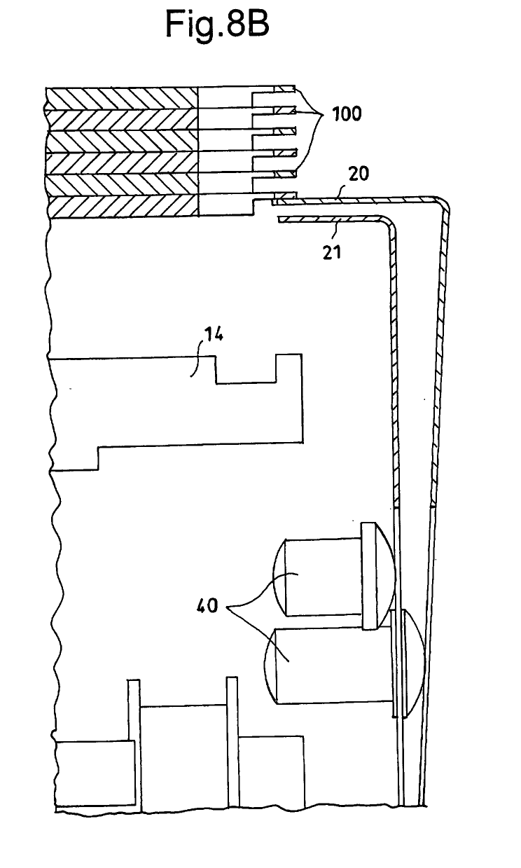

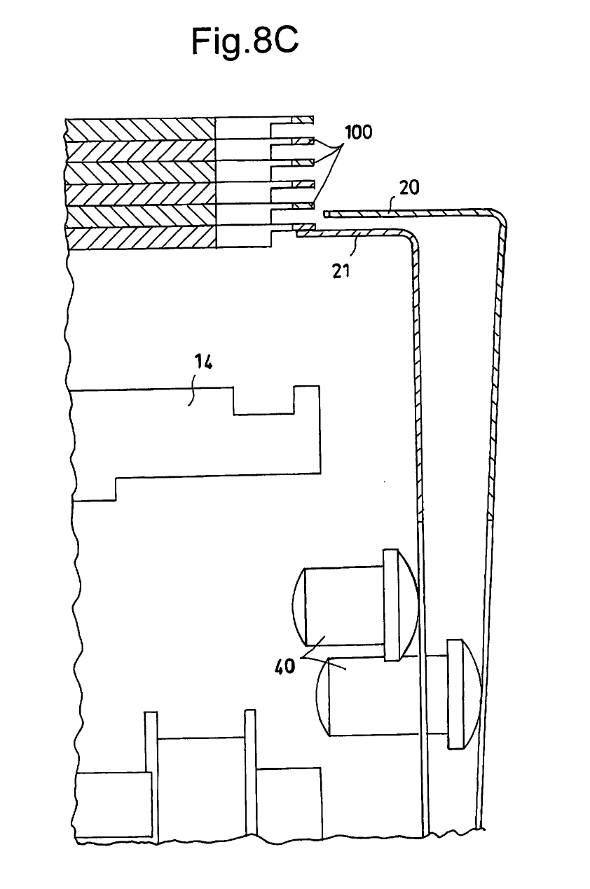

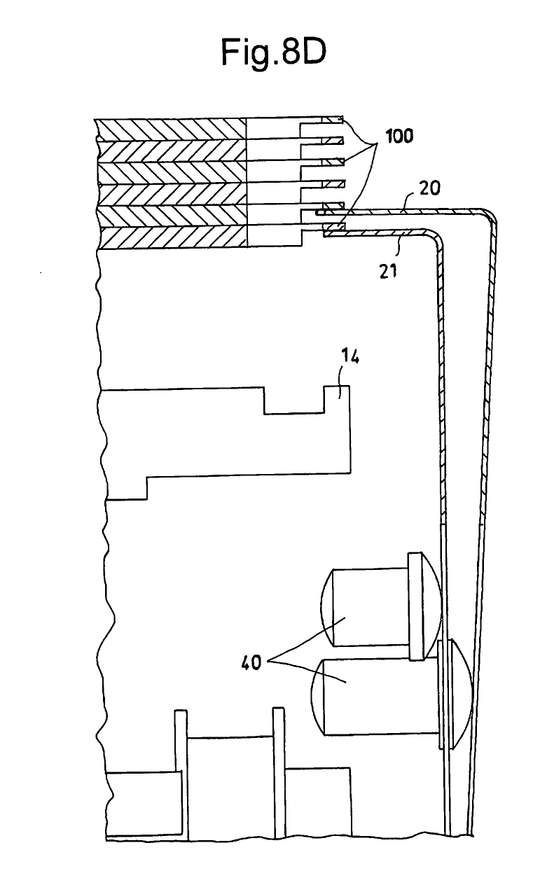

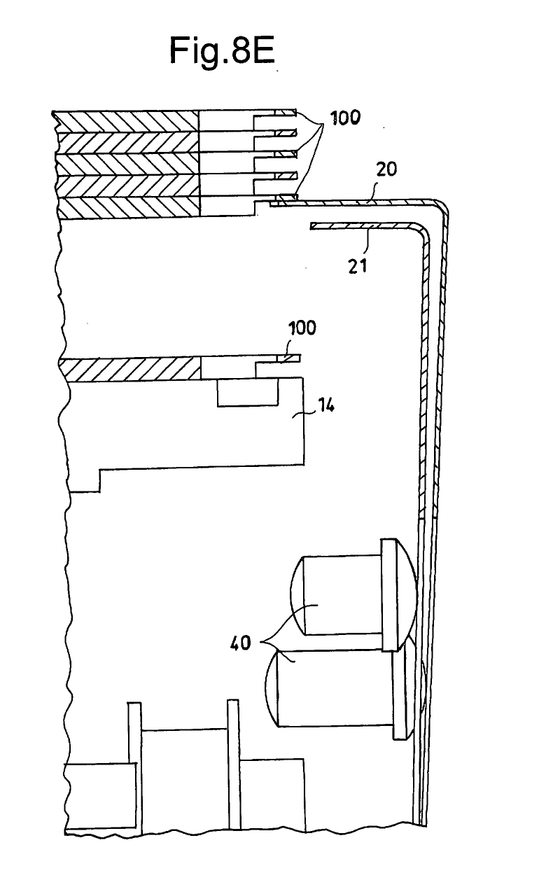

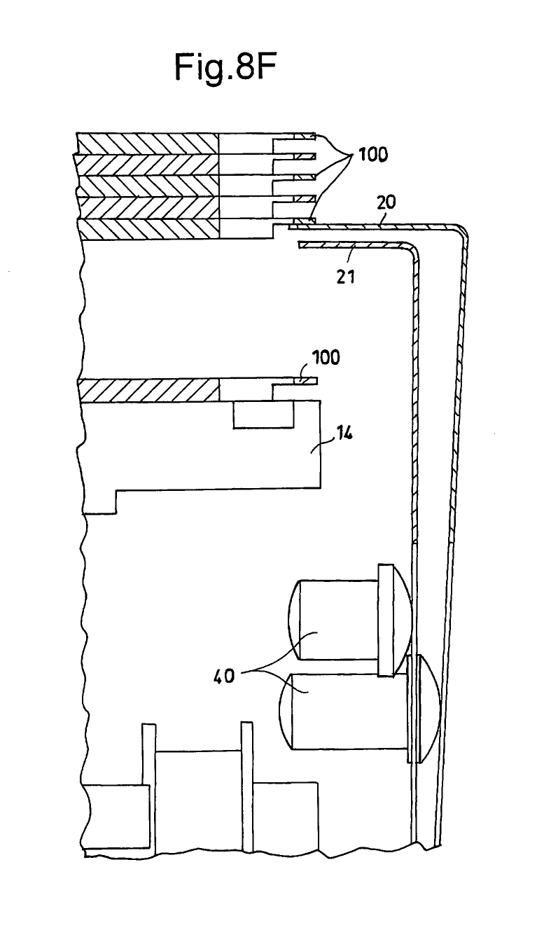

FIG. 8 shows the constructive details of the FIGS. 6, 6B, 6C during operation;

FIGS. 8B, 8C, 8D, 8E and 8F show various operation steps of the details shown in FIG. 8;

FIG. 9 shows a table during its advancing inside the printer of FIG. 1;

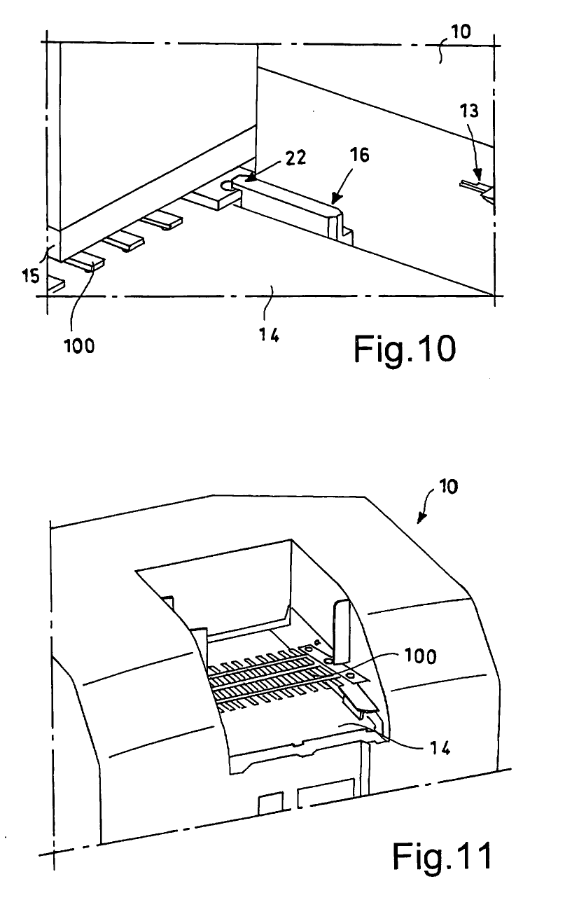

FIGS. 10, 11, 11B and 12 show other constructive details of the printer of FIG. 1.

With reference to the figures, an embodiment of a printer according to the present invention is shown with reference numeral 10 and a table structure for supporting and supplying groups of supports in such a printer 10 is shown with reference numeral 100.

Such a printer 10 comprises a housing 11, or loader, for receiving a plurality of tables 100 placed one on another, means for orienting 12 the tables 100 in the housing 11, means for supplying 13 a single table 100 at a time from the housing 11 to an advancing plane 14 towards a printing head 15 and means for moving 16 such a single table 100 unloaded on the advancing plane 14.

As means for orienting 12 the tables 100 in the housing 11 with respect to the printer 10, it can be foreseen for there to be a rib 12, visible in FIGS. 1 and 3, projecting inside the housing 11.

In particular, such a rib 12 extends parallel to the way of disposition of the tables 100 resting one on another and cooperating with a corresponding groove 102, shown in FIG. 2, obtained laterally with respect to the tables 100.

FIG. 3 shows how the rib 12 engages with the entire pile of tables 100, so that the tables 100 can be loaded into the printer 10 in only one predetermined direction.

Any loading error of the tables 100 into the printer 10 is therefore avoided.

In the present invention, the means for supplying 13 a single table 100 at a time from the housing 11 to the advancing plane 14 towards said printing head 15 comprise leafing devices 13 placed laterally and in a lower portion of the housing 11 so that the tables 100 inserted into the loader rest on the leafing devices 13 without coming into contact with the plane 14, placed partially below the housing.

In particular, such leafing devices 13 are mobile between a first extracted position, in which they maintain lifted the pile of tables 100, and a second retracted position, in which a single table 100 drops at a time from the housing 11 to the advancing plane 14.

As visible in the FIGS. 6B, 6C and 8, each of said leafing devices 13 comprises two blade elements 20, 21 placed one on another independently mobile.

Following the printing command, the upper blade 20 goes back into the structure of the printer and the table 100 resting above it, lowers resting with surfaces with smaller thickness 105 on the lower blade 21.

At this point, the upper blade 20 comes out again positioning itself between the table 100 in an unloading step and the one immediately above it.

Simultaneously, or straight after, the lower blade 21 goes back inside letting the table 100 to be printed drop from the housing 11 to the supplying plane 14.

The aforementioned coordinated movement steps of the blades 20 21 are shown in sequence in FIGS. 8B-8F.

As shown in the aforementioned figures, preferably the movement of the blades 20 21, is driven through cam pushers 40 acting independently, but in a synchronized way, on the blades 20, 21 themselves.

Since such blades 20, 21 act at the reduced-thickness areas 105, the loader 11 can receive tables 100 of any thickness as long as they are provided with same reduced-thickness areas 105.

As visible in FIG. 7, there are preferably three leafing devices 13 and they are positioned on the sides parallel to the printing direction, of which two leafing devices 13 are on one side and one is on the opposite side at the recesses 105 in the tables 100.

Their number makes it possible to ensure that the tables 100 always rest on all the present leafing devices 13.

As means for moving 16 the single table 100 on the advancing plane 14, it is foreseen for there to be pushers 16 equipped with restraining portions 22 of the tables 100, adherent to the advancing plane 14.

In such a way, the pushers 16 provide for pushing the table 100 towards the printing head 15, mobile only parallel to the plane 14, and simultaneously prevent the table 100 from lifting during the advancing steps.

Once the printing step is finished, the pushers 16 return to their initial position for receiving a new table 100.

In order to make the printer 10 capable of adapting to different table 100 thicknesses and to prevent accidental collisions of the printing head 15 with the table itself 100, the distance between the printing head 15 and the abutment 41 is fixed perpendicular to the advancing direction of the tables 100 and the advancing plane 14 is mobile perpendicular with respect to the advancing direction of the tables 100 until the tables are brought into contact with an abutment 41, in turn fixed at a predetermined distance that is suitable for the correct depositing of ink onto the table 100.

In such a way the abutment 41 prevents any possible collision between the printing head 15 and the table 100 as well as at the same time fixedly connecting the tables 100 irrespective of their thickness again at a predetermined distance that is suitable for the correct depositing of ink.

Advantageously, therefore as the thickness of the tables supplied varies, no calibration of the machine is required.

According to a preferred embodiment, the abutment can also be mobile with respect to the printing head so as to offer the printer 10 further adaptability to all types of tables.

The advancing of the table 100 on the plane 14 is moreover controlled also by means of a guide 24 for receiving pins 106, obtained on the lower surface of the tables 100, in which such a guide 24 becomes narrower starting from the housing 11 towards the printing head 15 for perfectly centring the table 100 during printing.

As shown in FIG. 4C at the pins for centring and sliding 106, 107 on the side opposite the table 100, housings 106b, 107b are foreseen for receiving pins 106, 107 so as to allow the tables 100 to be stably stacked one on another.

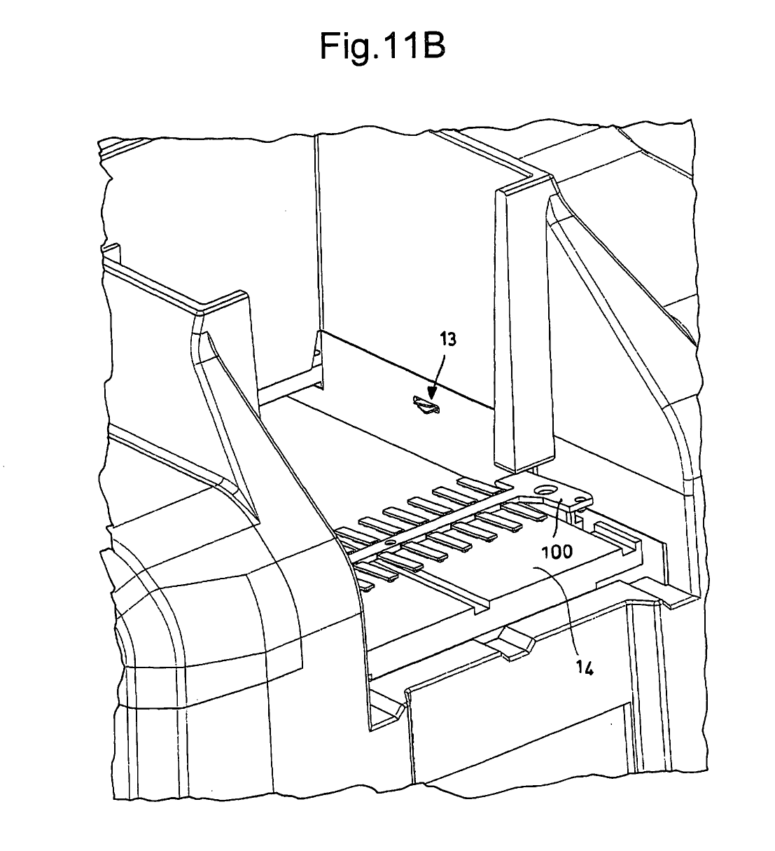

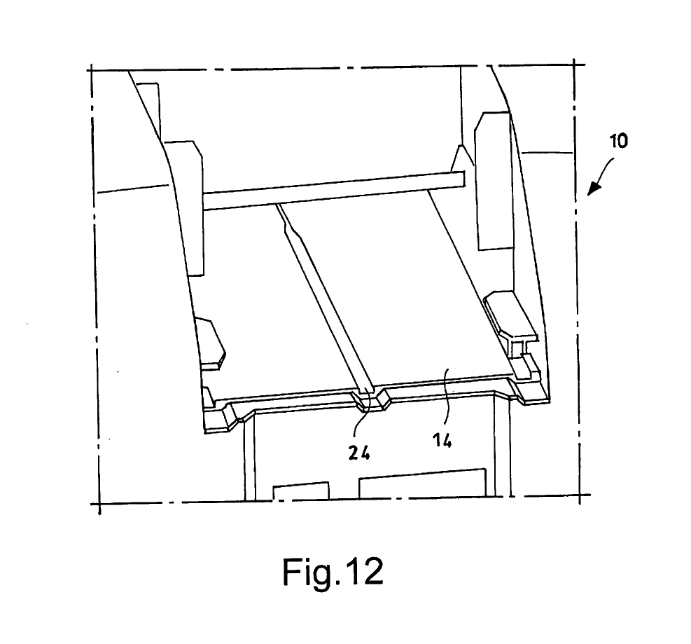

In the printer 10 it is finally foreseen for there to be also an area, shown in FIGS. 11, 11B and 12, of possible manual supply of the tables 100 on the plane 14.

Advantageously, such a manual supply can be carried out both with “whole” tables and with tables without certain elements thanks to the presence of the pins 106, 107 that in any case ensure the centring of such a small table on the plane 14.

As can partially be gathered from the description of the printer, also a table structure 100 for supporting and supplying products in such a printer 10 is object of the present invention.

As visible in FIGS. 4, 4B, 5, 5B, 5C, 5D, such a table structure 100 comprises a peripheral frame portion 104 for supporting a plurality of products 101 to be printed, in which the frame 104 is provided with a groove 102 for coupling with the rib 12 of the housing 11, with reduced-thickness areas 105 for cooperating with the leafing devices 13, with pins for sliding and centring 106 in the guide 24 obtained on the plane 14 and with pins for centring 107 the tables 100 with one another in the housing 11.

Moreover, the frame 104 can also comprise a hole 108 for moving the table 100.

Advantageously, the pins for sliding and centring 106 are positioned at the centreline of the table 100 so that possible positioning errors are halved and are shared by the two halves of the table itself 100.

It should be very easy to understand how the printer for products supported on a table object of the present invention operates.

Indeed, the printing procedure by means of the printer 10 comprises the steps of, loading the tables 100 into the housing 11 one on another, supplying a single table 100 at a time from the housing 11 to the advancing plane 14 towards the printing head 15 and moving such a single table 100 on the advancing plane 14.

In particular, all the aforementioned steps are controlled without positioning errors of the table 100 thanks to the rib 12, to the leafing devices 13 and to the pushers 16, respectively.

It has thus been seen that a printer and a table structure for supporting and supplying groups of supports in such a printer according to the present invention achieve the purposes previously highlighted.

Indeed, the printer for products supported on a table according to the present invention makes it possible to obtain a smooth printing without errors of positioning of the tables 100.

The printer for products supported on a table of the present invention thus conceived may undergo numerous modifications and variants, all covered by the same inventive concept; moreover, all the details can be replaced by technically equivalent elements. In practice, the materials used, as well as the sizes, may be of any type according to the technical requirements.

1) Printer (10) for groups of products (101) supported on a table structure (100) comprising a housing (11) for receiving a plurality of said tables (100) placed one on another, means for orienting (12) said tables (100) in said housing (11) as regard to said printer (10), means for supplying (13) of a single table (100) at a time from said housing (11) to an advancing plane (14) towards a printing head (15) and means for moving (16) said single table (100) on said advancing plane (14), characterized in that said means for supplying (13) of a single table (100) at a time from said housing (11) to said advancing plane (14) towards said printing head (15) comprise leafing devices (13) placed laterally and in a lower portion of said housing (11), said leafing devices (13) being mobile between a first position in which they maintain lifted the pile of said tables (100) from said advancing plane (14) and a second position in which a single table (100) drops from said housing (11) on said advancing plane (14).

2) Printer (10) according to claim 1 characterized in that said means for orienting (12) said tables (100) in said housing (11) as regard to said printer (10) comprise a rib (12) projecting in said housing (11) that develops parallel to the way of disposition of said tables (100) placed one on another, said rib (12) being in cooperation with a corresponding groove (102) obtained laterally to said tables (100).

3) Printer (10) according to claim 1 characterized in that each of said leafing devices (13) comprise two blade elements (20, 21) placed one on another mobile independently and in a synchronized way.

4) Printer (10) according to claim 3 characterized in that said blades (20, 21) are driven through cam pushers (40).

5) Printer (10) according to claim 1 characterized in that said means for moving (16) said single table (100) on said advancing plane (14) comprise pushers (16), said pushers (16) being provided with restraining portions (22) of said tables (100) adherent to said advancing plane (14).

6) Printer (10) according to claim 1 characterized in that said advancing plane (14) comprises a guide (24) for receiving pins (106) obtained on the lower surface of said tables (100).

7) Table structure (100) for supporting and supplying products in a printer according to claim 1 characterized in that it comprises a peripheral frame portion (104) for supporting a plurality of products (101) to be printed, said frame (104) comprises a groove (102) for coupling said rib (12) of said housing (11), reduced-thickness areas (105) for cooperating with said leafing devices (13), pins for centring and sliding (106) in said guide (24) obtained on said plane (14).

8) Table structure (100) according to claim 7 characterized in that said frame (104) comprises a hole (108) for moving said table (100).

9) Table structure (100) according to claim 7 characterized in that it comprises in correspondence with said pins for centring and sliding (106, 107) from the opposite side of said table (100) housings (106b, 107b) of said pins (106, 107) for firmly piling of said tables (100) one on another.
